(19) United States
(12) Patent Application Publication
(10) Pub. No.: US 2010/0244391 A1
(43) Pub. Date: Sep. 30, 2010

(54) SEALING DEVICE OF VAPORIZATION ROOM OF A STEAM IRON

(76) Inventor: Tuming YOU, Fujian (CN)

Correspondence Address: RABIN & Berdo, PC, 1101 14TH STREET, NW, SUITE 500, WASHINGTON, DC, 20005, US

(21) Appl. No.: 12/714,682

(22) Filed: Mar. 1, 2010

(30) Foreign Application Priority Data
Mar. 31, 2009 (CN) 200920137346.0

(51) Int. Cl. F16J 15/06

(52) U.S. Cl. 277/650

(57) ABSTRACT

The present invention relates to a steam iron, especially relates to a sealing device of vaporization room of a steam iron which comprises a vaporization room body and a cover, sealing ribs are projecting disposed on the lower surface of the cover, and sealing slots are disposed on the corresponding positions of the vaporization room body, the sealing ribs are inserted into the sealing slots so as to combine the cover and the vaporization room body to form a sealed vaporization room. In the present invention, the cooperation of the sealing ribs and the sealing slots would seal the vaporization room body and the cover, and when the temperature is high, the sealing ribs are expanding to block the sealing slots completely, thus the sealing effect is better and stable.

### THE FIELD OF THE INVENTION

The present invention relates to a steam iron, especially relates to a sealing device of vaporization room of a steam iron.

### THE BACKGROUND OF THE INVENTION

A vaporization room is disposed in a steam iron, and a cover is disposed on the vaporization room, covering it. They are sealed with a seal gasket, typically a silica gel gasket. The conventional sealing method has the following problems in practical application:
1. In the long-term high pressure and high temperature, the seal gasket becomes deformed so as to produce gaps between the vaporization room and the cover and result in the problem that steam leak from the gaps. So a safety issue of the product is unavoidable.
2. Owing to oily substance on the seal gasket, the steam becomes dirty and the use effect is not good.
3. Because a seal gasket is needed, the manufacturing cost is increased, and the operation and the maintenance of equipment are inconvenient.

### SUMMARY OF THE INVENTION

The main purpose of the present invention is to overcome the shortage that the vaporization room of the conventional iron could not be sealed in good condition, and provide a sealing device of vaporization room of a steam iron which could achieve a good seal effect.

The present invention applies the following technical solutions:

Technical solution 1:

A sealing device of vaporization room of a steam iron comprising:
a vaporization room body, which has a bottom board on which at least a circle of wall is disposed;
and a cover,

the lower surface of the cover protrudes downwardly to form at least a sealing rib corresponding to the wall, and at least a corresponding sealing slot is disposed on the walls of the vaporization room body, the sealing rib is inserted into the sealing slot so that the cover and the vaporization room body could be combined together and form a sealed vaporization room.

Said bottom board of the vaporization room is a soleplate of the iron, and a first wall disposed on the periphery of the bottom board, a steam outlet is positioned inside said first wall, the lower surface of the periphery of said cover protrudes downwardly to form a first sealing rib, and a first sealing slot which is adapted to the first sealing rib is formed on the first wall, the first sealing rib is inserted into the first sealing slot so as to make the cover sealed with the vaporization room body.

Said vaporization room includes a vaporization chamber and a steam distribution chamber, which are separated from each other by a second wall and are connected by a steam channel; the bottom of said steam distribution chamber is said soleplate with several steam holes; a second sealing slot is disposed on the second wall, and a second sealing rib which is adapted to said second sealing slot disposed on the corresponding position of the lower surface of said cover.

Said vaporization chamber includes a main vaporization chamber and a vice vaporization chamber, which are separated from each other by a third wall that has a third sealing slot, a third sealing rib which is adapted to the third sealing slot is disposed on the corresponding position of the lower surface of said cover.

Said third rib, said second rib, said first rib and said cover are an integrated unity made of aluminum alloy.

Said vaporization room includes a vaporization chamber and a steam distribution chamber, which are separated from each other by a second wall and are connected by a steam channel; the bottom of said steam distribution chamber is said soleplate with several steam holes; said second wall has a second sealing rib, correspondingly a second sealing slot which is adapted to the second sealing rib and disposed on corresponding position of lower surface of said cover.

Said vaporization chamber includes a main vaporization chamber and a vice vaporization, which are separated from each other by a third wall on which a third sealing rib is disposed. Correspondingly, a third sealing slot which is adapted to said third sealing rib disposed on corresponding position of the lower surface of said cover.

Said ribs and said slots are made of aluminum or aluminum alloy, and the connection between them is interference fit or tight fit.

Technical solution 2:

A sealing device of vaporization room of a steam iron comprises a vaporization room body with a bottom board and a cover, the lower surface of the cover protrudes downwardly to form sealing slot, and sealing rib is formed in the corresponding position of the vaporization room so that the sealing rib is inserted into the sealing slot so as to combine the cover and the vaporization room body to form a sealed vaporization room.

The bottom board of the vaporization room is the soleplate of the iron, on the periphery of which a first wall is disposed, and the lower surface of the periphery of the cover protrudes downwardly to form a first sealing slot, a first sealing rib which is adapted to said first sealing slot formed on the first wall, the first sealing rib is inserted into the first sealing slot so as to make the cover sealed with the vaporization room body.

Said vaporization room includes a vaporization chamber and a steam distribution chamber, which are separated from each other by a second wall and connected by a steam channel; the bottom of said steam distribution chamber is said soleplate with several steam holes; a second sealing rib is disposed on the second wall, and correspondingly a second sealing slot which is adapted to said second sealing rib disposed in the corresponding position of the lower surface of said cover.

Said vaporization chamber includes a main vaporization chamber and a vice vaporization chamber, which are separated from each other by a third wall with a third sealing rib on it, correspondingly, a third sealing slot which is adapted to the third sealing rib disposed on the corresponding position of the lower surface of said cover.

Technical solution 3:

A sealing device of vaporization room of a steam iron comprising:

a vaporization room body, which has a bottom board;

and a cover,

the lower surface of the cover protrudes downwardly to form a circle of rib, and a sealing slot corresponding to the rib is disposed on the bottom of the vaporization room, the sealing rib is inserted into the sealing slot so as to combine the cover and the vaporization room body to form a vaporization room.

Said ribs and said slot are made of aluminum or aluminum alloy, and the connection between them is interference fit or tight fit.

From the above descriptions of the present invention, compared to the conventional technique, in the sealing device of vaporization room of a steam iron of the present invention, the vaporization room body and the cover are sealed together by the connection of the sealing rib and the sealing slot which takes place of the seal gasket. In the actual production, the thermal expansion coefficient of the material of the sealing ribs should be greater than that of the material of the sealing slots, so that when temperature is high the sealing ribs would be expanded to seal the sealing slots completely. The effect of sealing is safe and stable; besides, without seal gasket, the manufacturing cost of the present invention is reduced.

### BRIEF DESCRIPTION OF THE DRAWINGS

FIG. 1 is a schematic view of the vaporization room body in the preferred embodiment 1 of the present invention.

FIG. 2 is a schematic view of the cover in the preferred embodiment 1 of the present invention.

FIG. 3 is a schematic view of the vaporization room body in the preferred embodiment 2 of the present invention.

FIG. 4 is a schematic view of the cover in the preferred embodiment 2 of the present invention.

### DESCRIPTION OF SPECIFIC EMBODIMENTS

The present invention will become apparent with the reference to the preferred embodiment.

### Embodiment 1

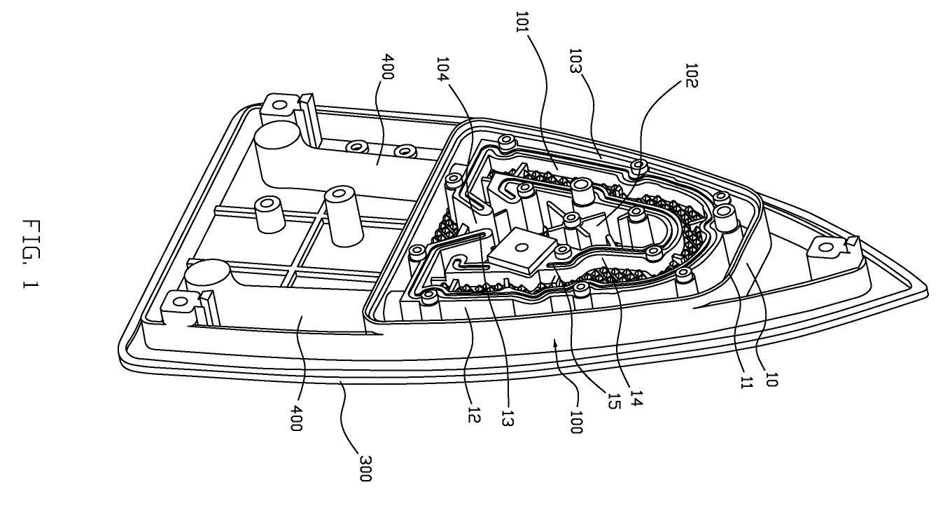

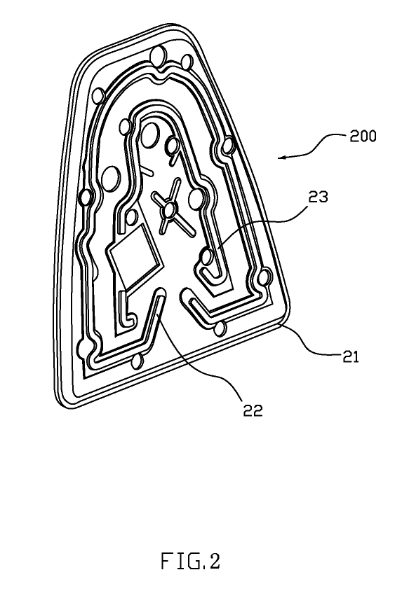

Referring to FIG. 1 and FIG. 2, the sealing device of vaporization room of a steam iron comprises a vaporization room body 100 and a cover 200, and the vaporization room body 100 is disposed on an ironing board 300.

A first wall 10 is disposed on the periphery of the vaporization room body 100 and separates it with the outside. A second wall 12 and a third wall 14 are disposed in the vaporization room body 100, and the first wall 10 and the second wall 12 form a steam distribution chamber 103. The bottom of the steam distribution chamber 103 is ironing board 300 in which several steam spouts are disposed; the second wall 12 and the third wall 14 form a main vaporization chamber 101 through which electric heating tube is disposed; the third wall 14 forms a vice-vaporization chamber 102. The main vaporization chamber 101 and the vice-vaporization chamber 102 are respectively connected to the steam distribution chamber 103 by a steam channel 104.

A first sealing slot 11, a second sealing slot 13 and a third sealing slot 15 are respectively disposed in the first wall 10, the second wall 12 and the third wall 14. A first sealing rib 21, a second sealing rib 22 and a third sealing rib 23 are disposed in corresponding positions of the bottom of the cover 200, and they are respectively inserted into the first sealing slot 11, the second sealing slot 13 and the third sealing slot 15. In manufacturing, the first sealing rib 21, the second sealing rib 22, the third sealing rib 23 and the cover 200 are integrated and made of aluminum alloy. And the first wall 10, the second wall 12, the third wall 14 and the three sealing slots 11, 13, 15 in the walls are made of iron. Because the thermal expansion coefficient of aluminum alloy are greater than that of iron, when the cover 200 are heated, the first sealing rib 21, the second sealing rib 22 and the third sealing rib 23 are heated to expand in order to seal the first sealing slot 11, the second sealing slot 13 and the third sealing slot 15 completely. The sealing effect is better and the problem of dirty steam in the seal gasket could be avoided.

### Embodiment 2

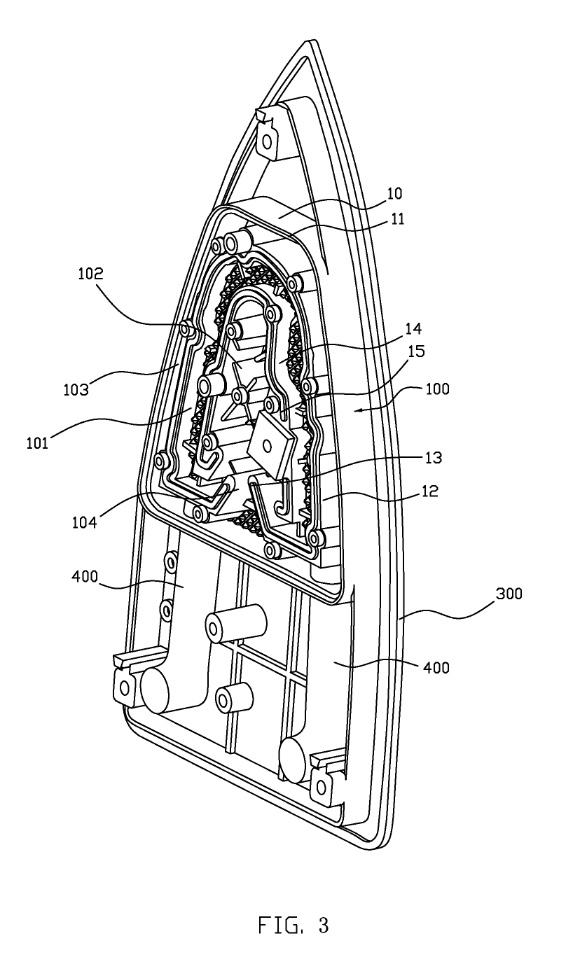

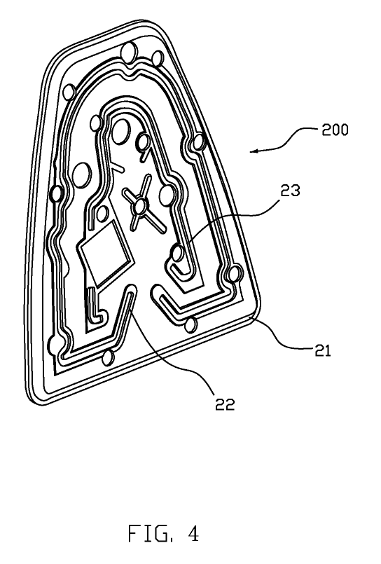

Referring to FIG. 3 and FIG. 4, the sealing device of vaporization room of a steam iron comprises a vaporization room body 100 and a cover 200, and the vaporization room body 100 is disposed on an ironing board 300.

A first wall 10 is disposed on the periphery of the vaporization room body 100 and separates it with the outside. A second wall 12 and a third wall 14 are disposed in the vaporization room body 100, and the first wall 10 and the second wall 12 form a steam distribution chamber 103. The bottom of the steam distribution chamber 103 is ironing board 300 in which several steam spouts are disposed; the second wall 12 and the third wall 14 form a main vaporization chamber 101 through which electric heating tube is disposed; the third wall 14 forms a vice-vaporization chamber 102. The main vaporization chamber 101 and the vice-vaporization chamber 102 are respectively connected to the steam distribution chamber 103 by a steam channel 104.

A first sealing rib 11, a second sealing rib 13 and a third sealing rib 15 are respectively disposed in the first wall 10, the second wall 12 and the third wall 14. A first sealing slot 21, a second sealing slot 22 and a third sealing slot 23 are respectively are disposed in corresponding positions of the bottom of the cover 200, and the first sealing rib 11, the second sealing rib 13 and the third sealing rib 15 are respectively inserted into the first sealing slot 11, the second sealing slot 13 and the third sealing slot 15.

All above is just two embodiments of the present invention, but the present invention is not limited in the two embodiments. All the alternations and modifications of the present invention should be in the scope of the present invention.

What the claim is:

1. A sealing device of vaporization room of a steam iron comprising:
a vaporization room body, which has a bottom board on which at least a circle of wall is disposed;
and a cover,
wherein the lower surface of the cover protrudes downwardly to form at least a sealing rib corresponding to the wall, and at least a corresponding sealing slot is disposed on the walls of the vaporization room body, the sealing rib is inserted into the sealing slot so that the cover and the vaporization room body could be combined together and form a sealed vaporization room.

2. The sealing device of vaporization room of a steam iron according to claim 1, wherein said bottom board of the vaporization room is a soleplate of the iron, and a first wall disposed on the periphery of the bottom board, a steam outlet is positioned inside said first wall, the lower surface of the periphery of said cover protrudes downwardly to form a first sealing rib, and a first sealing slot which is adapted to the first sealing rib is formed on the first wall, the first sealing rib is inserted into the first sealing slot so as to make the cover sealed with the vaporization room body.

3. The sealing device of vaporization room of a steam iron according to claim 2 wherein said vaporization room includes a vaporization chamber and a steam distribution chamber, which are separated from each other by a second wall and are connected by a steam channel; the bottom of said steam distribution chamber is said soleplate with several steam holes; a second sealing slot is disposed on the second wall, and a second sealing rib which is adapted to said second sealing slot disposed on the corresponding position of the lower surface of said cover.

4. The sealing device of vaporization room of a steam iron according to claim 3 wherein said vaporization chamber includes a main vaporization chamber and a vice vaporization chamber, which are separated from each other by a third wall that has a third sealing slot, a third sealing rib which is adapted to the third sealing slot is disposed on the corresponding position of the lower surface of said cover.

5. The sealing device of vaporization room of a steam iron according to claim 4 wherein said third rib, said second rib, said first rib and said cover are an integrated unity made of aluminum alloy.

6. The sealing device of vaporization room of a steam iron according to claim 2 wherein said vaporization room includes a vaporization chamber and a steam distribution chamber, which are separated from each other by a second wall and are connected by a steam channel; the bottom of said steam distribution chamber is said soleplate with several steam holes; said second wall has a second sealing rib, correspondingly a second sealing slot which is adapted to the second sealing rib and disposed on corresponding position of lower surface of said cover.

7. The sealing device of vaporization room of a steam iron according to claim 6 wherein said vaporization chamber includes a main vaporization chamber and a vice vaporization, which are separated from each other by a third wall on which a third sealing rib is disposed. Correspondingly, a third sealing slot which is adapted to said third sealing rib disposed on corresponding position of the lower surface of said cover.

8. The sealing device of vaporization room of a steam iron according to claim 1 wherein said ribs and said slots are made of aluminum or aluminum alloy, and the connection between them is interference fit or tight fit.

9. A sealing device of vaporization room of a steam iron comprises a vaporization room body with a bottom board and a cover wherein the lower surface of the cover protrudes downwardly to form sealing slot, and sealing rib is formed in the corresponding position of the vaporization room so that the sealing rib is inserted into the sealing slot so as to combine the cover and the vaporization room body to form a sealed vaporization room.

10. The sealing device of vaporization room of a steam iron according to claim 9 wherein the bottom board of the vaporization room is the soleplate of the iron, on the periphery of which a first wall is disposed, and the lower surface of the periphery of the cover protrudes downwardly to form a first sealing slot, a first sealing rib which is adapted to said first sealing slot formed on the first wall, the first sealing rib is inserted into the first sealing slot so as to make the cover sealed with the vaporization room body.

11. The sealing device of vaporization room of a steam iron according to claim 10 wherein said vaporization room includes a vaporization chamber and a steam distribution chamber, which are separated from each other by a second wall and connected by a steam channel; the bottom of said steam distribution chamber is said soleplate with several steam holes; a second sealing rib is disposed on the second wall, and correspondingly a second sealing slot which is adapted to said second sealing rib disposed in the corresponding position of the lower surface of said cover.

12. The sealing device of vaporization room of a steam iron according to claim 11 wherein said vaporization chamber includes a main vaporization chamber and a vice vaporization chamber, which are separated from each other by a third wall with a third sealing rib on it, correspondingly, a third sealing slot which is adapted to the third sealing rib disposed on the corresponding position of the lower surface of said cover.

13. A sealing device of vaporization room of a steam iron comprising:
a vaporization room body, which has a bottom board;
and a cover,
wherein the lower surface of the cover protrudes downwardly to form a circle of rib, and a sealing slot corresponding to the rib is disposed on the bottom of the vaporization room, the sealing rib is inserted into the sealing slot so as to combine the cover and the vaporization room body to form a vaporization room.

14. The sealing device of vaporization room of a steam iron according to claim 13 wherein said ribs and said slot are made of aluminum or aluminum alloy, and the connection between them is interference fit or tight fit.
